(19) United States
(12) Patent Application Publication
(10) Pub. No.: US 2024/0072555 A1
(43) Pub. Date: Feb. 29, 2024

(54) Beverage Receptacle With Dual Mobile Device Holder

(71) Applicant: Research & Design Innovations, LLC, Branford, CT (US)

(72) Inventors: Donald Terry Allen, Madison, CT (US); Ryh Yeh, Virginia Beach, VA (US)

(21) Appl. No.: 18/238,799

(22) Filed: Aug. 28, 2023

Related U.S. Application Data
(60) Provisional application No. 63/442,864, filed on Feb. 2, 2023.
(60) Provisional application No. 63/421,311, filed on Nov. 1, 2022.
(60) Provisional application No. 63/402,736, filed on Aug. 31, 2022.

(51) Int. Cl. H02J 7/00; A47G 19/22; H02J 50/10

(52) U.S. Cl. CPC H02J 7/0044; A47G 19/2227; H02J 50/10; A47G 2019/2238; A47G 2400/00

(57) ABSTRACT

A device holder for wirelessly providing power to at least one mobile device, and method of installation. The device holder comprises a housing having a vertically extending first device well and a vertically extending second device well, either of the device wells configured for receiving at least one mobile device. A charging element is central to the housing and between the device wells. The charging element including a front and rear surfaces in communication with the device wells and has wireless charging circuitry for wirelessly charging at least one mobile device inserted within a device well.

### BACKGROUND OF THE INVENTION

### 1. Field of the Invention

The present invention relates to an apparatus, system, and method, for permanent waterproof installation into marine craft or land recreational vehicle(s), to hold and wirelessly charge portable electronic devices.

### 2. Description of the Related Art

Portable electronic devices are increasingly used and relied upon in both business and personal environments. Examples of such devices are mobile phones, smart phones, music players, and the like. Such mobile devices are provided with a battery for storing energy, and incorporate elements which allow charge/recharge operations of the battery by means of an inductive battery charger. Such chargers enable wireless power transfer to the mobile device without wires and/or electronic connectors. These inductive battery chargers have become increasingly popular, as they may perform charging/recharging operations on mobile devices without need for model-specific connectors.

Within marine craft and land recreational vehicle(s) (hereinafter, “motorized vessels”), mobile devices are generally placed within open bins, cupholders, trays, and the like when not in use. These locations are often subject to outdoor environments, such as the open seas, and movement of the vessel or vehicle can cause shifting and/or dislodgement of the mobile device from the stored location. In such cases, wear, damage, and even loss of the mobile device can occur. Thus, there exists a need for a storage means within motorized vessel(s) which can safely store a mobile device while simultaneously providing charge/recharge operations of the mobile device battery when not in use.

### SUMMARY OF THE INVENTION

Bearing in mind the problems and deficiencies of the prior art, it is therefore an object of the present invention to provide a safe and secure storage solution to a mobile device within motorized vessel(s).

It is another object of the present invention to provide storage of any mobile device(s) which may performing wireless charging/recharging operations of the device battery when not in use.

It is yet another object of the present invention to provide storage and/or wireless charge/recharge options to a plurality of mobile devices simultaneously in a single storage housing.

It is a further object of the present invention to provide storage and/or wireless charge/recharge options for mobile device(s) utilizing any pre-existing beverage receptacle(s) of a motorized vessel.

Another object of the present invention is to provide portable storage for mobile device(s) in a motorized vessel capable of performing wireless charge/recharge operations.

Still other objects and advantages of the invention will in part be obvious and will in part be apparent from the specification.

The above and other objects, which will be apparent to those skilled in the art, are achieved in the present invention which is directed to a device holder for wirelessly providing power to at least one mobile device. The device holder comprises a housing having a vertically extending first device well and a vertically extending second device well, the device wells configured for receiving at least one mobile device. A charging element may be disposed central to the housing and between the first and second device well, the charging element including a front surface in communication with the first or second device well, a rear surface in communication with the second or first device well, and wireless charging circuitry adapted to wirelessly charge at least one mobile device inserted into the first and/or second device wells. Upon placement of at least one mobile device within the first and/or second device well, the charging element front surface and/or rear surface perform wireless charging of the at least one mobile device.

Another aspect of the present invention is to provide a device holder for wirelessly providing power to at least one mobile device, the device holder disposed within a beverage receptacle of a motorized vessel. The device holder comprises an inner housing having a vertically extending first device well and a vertically extending second device well, the device wells configured for receiving at least one mobile device. A first charging element may be within the inner housing, the first charging element in communication with one of the device wells and including wireless charging circuitry adapted to wirelessly charge at least one mobile device inserted into the one of the device wells. A second charging element may be within the inner housing, the second charging element in communication with the other of the device wells and including wireless charging circuitry adapted to wirelessly charge at least one mobile device inserted into the other of the device wells. A cover portion may enclose the device wells, the cover portion including tab portions in communication with the device wells to bias at least one mobile device inserted within the first and/or second device well towards the first and/or second charging element. Upon placement of at least one mobile device within the first and/or second device well, wireless charging of the at least one mobile device may occur via the first and/or second charging element.

Yet another aspect of the present invention is to provide a device holder for wirelessly providing power to at least one mobile device. The device holder comprises a resilient housing comprising a top surface, a bottom surface, and enclosed by sidewalls. A device holder housing may be disposed within the resilient housing, the device holder having a plurality of device wells, each of the plurality of device wells configured for receiving at least one mobile device; a beverage receptacle disposed on the resilient housing top surface. The resilient housing may include a connection element for receiving a removable power cell for supplying electrical energy to the resilient housing. Each of the plurality of device wells may include a charging element including wireless charging circuitry adapted to wirelessly charge at least one mobile device inserted into at least one of the plurality of device wells so that upon placement of at least one mobile device within at least one of the plurality of device wells, the charging element perform wireless charging of the at least one mobile device.

Another aspect of the present invention is to provide a device holder for wirelessly providing power to at least one mobile device. The device holder comprises a housing secured within a beverage receptacle of a motorized vessel, the housing having a vertically extending first device well and a vertically extending second device well, the device wells configured for receiving at least one mobile device. A charging element may be disposed central to the housing and between the first and second device well, the charging element including a front surface in communication with the first or second device well, a rear surface in communication with the second or first device well, and wireless charging circuitry adapted to wirelessly charge at least one mobile device inserted into the first and/or second device wells. Upon placement of at least one mobile device within the first and/or second device well, the charging element front surface and/or rear surface may perform wireless charging of the at least one mobile device.

In some embodiments, the device holder comprises a shroud or cover coupled to an end of the housing, the shroud or cover capable of encapsulating the device wells. The device holder may be secured within a beverage receptacle of a motorized vessel, and the beverage receptacle may include lighted elements to indicate one or more parameters of the device holder, such as when at least one mobile device is charging or fully charged, when at least one mobile device has been properly and/or improper placement within the first and/or second device well, when the device holder is damaged, malfunction or in need of service, and combinations thereof. The charging element wireless charging circuitry may be adapted to wirelessly charge a plurality of mobile devices inserted into the first and/or second device well. The charging element front surface may perform wireless charging of one of the plurality of mobile devices inserted into the first device well and/or the second device well and the rear surface may perform wireless charging of the other of the plurality of mobile devices inserted into the second device well and/or the first device well. The housing may be constructed of a UV enhanced material.

The device holder may comprise a plurality of shroud portions coupled to an end of the housing, each of the plurality of shroud portions adapted to be received within one of the device wells, each of the plurality of shroud portions comprising stanchion members and connecting projections. An end of the housing may include an insertion member to enclose the device wells, the insertion member including tab portions in communication with the device wells. Each of the device wells include a ramped member configured to bias at least one mobile device inserted into the first and/or second device well toward the charging element. The device holder may comprise a connecting element capable of supplying electrical power to the device holder via an external power source.

A plurality of beverage receptacles may be disposed on the resilient housing top surface. The device holder may be disposed within an interior chamber on one of the sidewalls of the resilient housing. The device holder may be disposed within one of the plurality of beverage receptacle, the device holder including a cover portion enclosing the device wells, the cover portion including tab portions in communication with the device wells to bias at least one mobile device inserted into at least one of the plurality of device wells towards the charging element. The device holder may include an electrical connector in the resilient housing capable of supplying electrical power to the device holder via an external power source.

Another aspect of the present invention is to provide a method of installing a device holder for wirelessly providing power to at least one mobile device within a beverage receptacle of a motorized vessel. The method comprises the steps of feeding an electrical connector of a device holder through a bottom surface opening of a beverage receptacle, the beverage receptacle received within a selected surface of a motorized vessel; placing the electrical connector of the device holder into an interior of the motorized vessel; connecting the electrical connector of the device holder with an external power source of the motorized vessel; sealing the bottom surface opening of the beverage receptacle; placing the device holder within a cavity of the beverage receptacle; and engaging the device holder with sidewalls of the beverage receptacle to prevent shifting of at least one mobile device placed within the device holder during operation of the motorized vessel.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a perspective view of a portion of a device holder according to one embodiment of the present invention;

FIG. 2 depicts a top plan view of a device holder according to one embodiment of the present invention, disposed within a beverage receptacle of a motorized vessel;

FIG. 3 depicts a cross-sectional view of the device holder of FIG. 2;

FIG. 4 depicts an exploded view of a device holder according to one embodiment of the present invention;

FIG. 5 depicts a perspective view of the device holder according to one embodiment of the present invention;

FIG. 6 depicts a perspective view of a device holder according to one embodiment of the present invention;

FIG. 7A depicts a perspective view of a device holder according to one embodiment of the present invention, with mobile devices;

FIG. 7B depicts a perspective view of a device holder according to one embodiment of the present invention, with a mobile device;

FIG. 8 depicts a perspective view of a portion of a device holder according to one embodiment of the present invention;

FIG. 9 depicts a perspective view of a device holder according to one embodiment of the present invention, with electrical connector;

FIG. 10 depicts a perspective view of the device holder according to one embodiment of the present invention, with electrical connector;

FIG. 11 depicts a perspective view of electrical connectors of a device holder according to one embodiment of the present invention;

FIG. 12 depicts an exploded perspective view of a portion of a device holder according to one embodiment of the present invention;

FIG. 13 depicts a perspective view of a device holder according to one embodiment of the present invention;

FIG. 14 depicts a perspective view of the device holder according to one embodiment of the present invention, with a mobile device inserted therein;

FIG. 15 depicts a perspective view of the device holder according to one embodiment of the present invention, with mobile devices inserted therein;

FIG. 16 depicts a perspective view of a portion of the device holder according to one embodiment of the present invention;

FIG. 17 depicts a perspective view of a portion of the device holder of FIG. 16;

FIG. 18A depicts a perspective view of a portion of the device holder of FIG. 16;

FIG. 18B depicts a perspective view of a portion of the device holder displaying ribs according to one embodiment of the present invention;

FIG. 19 depicts a cross sectional view of a portion of the device holder according FIG. 16, with a mobile device inserted therein;

FIG. 20 depicts a top plan view of a device holder according to one embodiment of the present invention;

FIG. 21 depicts a cross-sectional view of the device holder of FIG. 20, along lines A-A and with mobile devices;

FIG. 22 depicts a top perspective view of a device holder according to one embodiment of the present invention;

FIG. 23 depicts a bottom perspective view of the device holder of FIG. 22;

FIG. 24 depicts a bottom perspective view of a portion of the device holder of FIG. 22;

FIG. 25 depicts a perspective view of a portion of the device holder of FIG. 22; and

FIG. 26 depicts a top plan view of a device holder according to one embodiment of the present invention, displaying multiple device holders.

### DETAILED DESCRIPTION OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the singular forms “a”, “an” and “the” are intended to include the plural forms as well, unless the context clearly indicates otherwise. Also, as used herein, the term “and/or” includes any and all combinations of one or more of the associated listed items. It will be further understood that the terms “include” and/or “including” when used herein, specify the presence of stated features, steps, operations, elements, and/or components, but do not preclude the presence or addition of one or more other features, steps, operations, elements, components, and/or groups thereof.

Relative terms such as “below,” “above,” “upper,” “lower,” “horizontal,” “vertical,” “top,” “bottom,” “rear,” “front,” “side,” or the like may be used herein to describe a relationship of one element or component to another element or component as illustrated in the figures. It will be understood that these terms are intended to encompass different orientations of the device in addition to the orientation depicted in the figures.

Additionally, in the subject description, the words “exemplary,” “illustrative,” or the like are used to mean serving as an example, instance or illustration. Any aspect or design described herein as “exemplary” or “illustrative” is not necessarily intended to be construed as preferred or advantageous over other aspects or design. Rather, use of the words “exemplary” or “illustrative” is merely intended to present concepts in a concrete fashion.

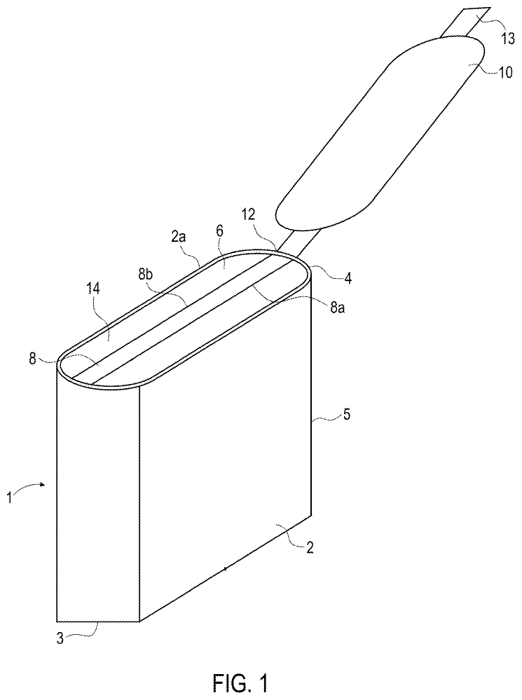

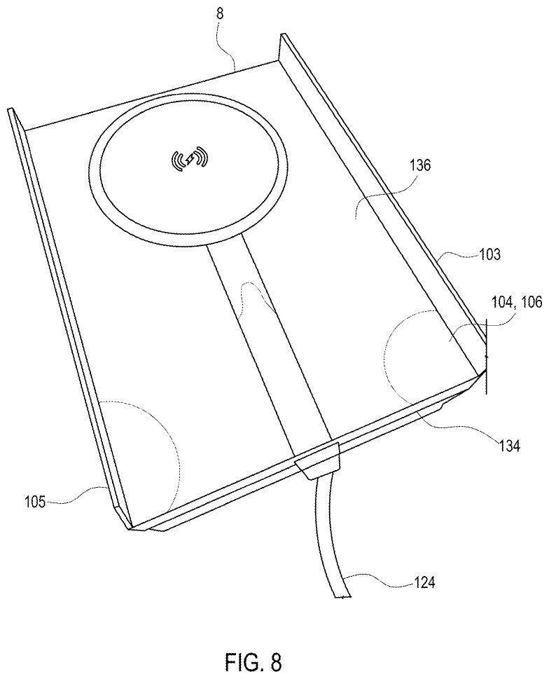

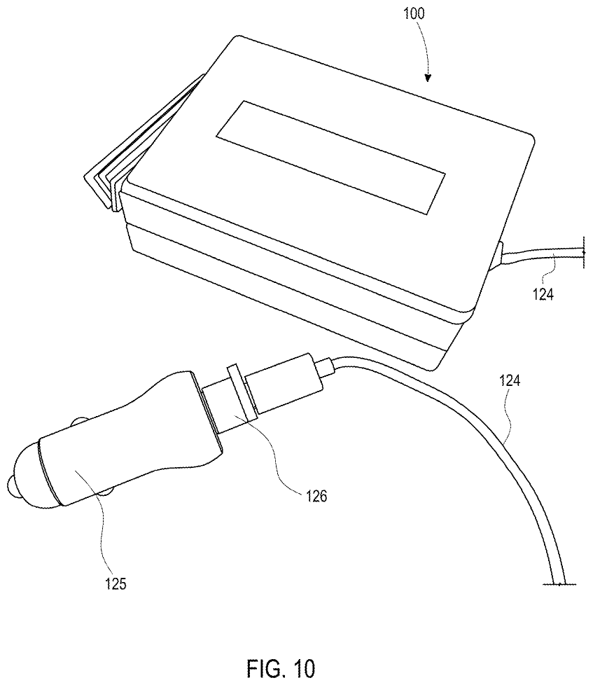

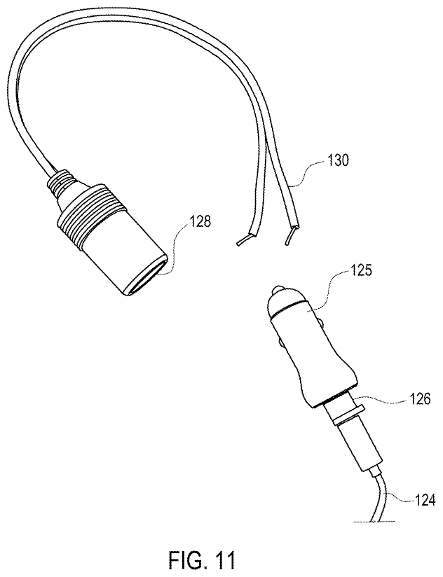

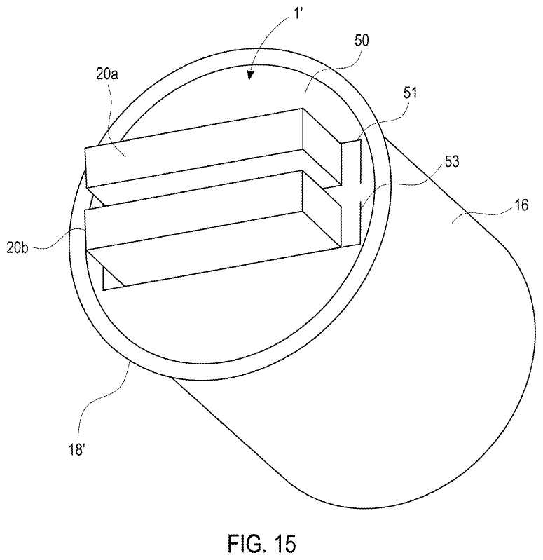

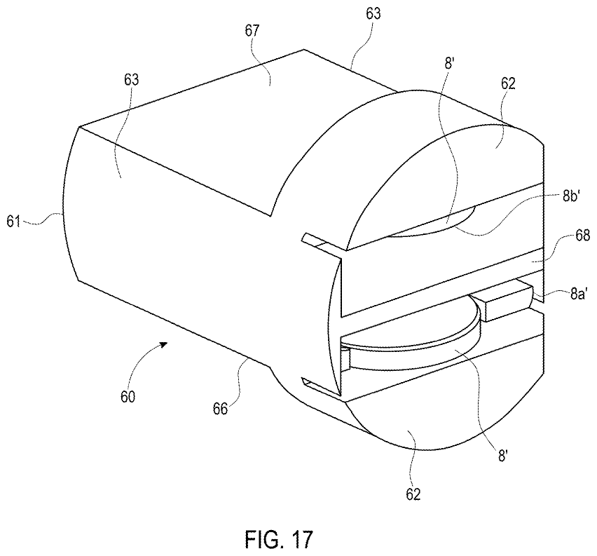

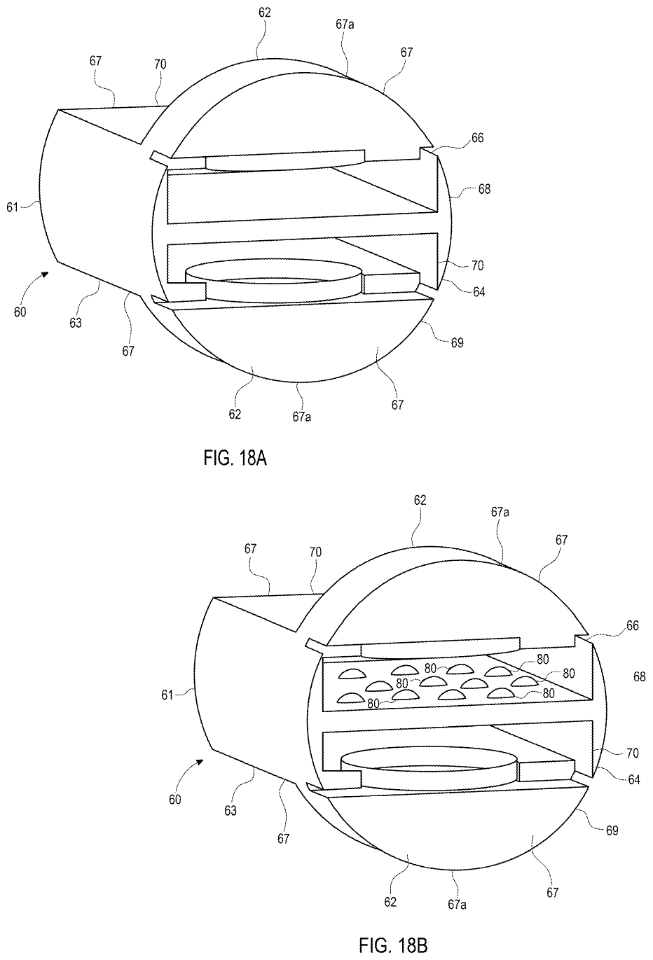

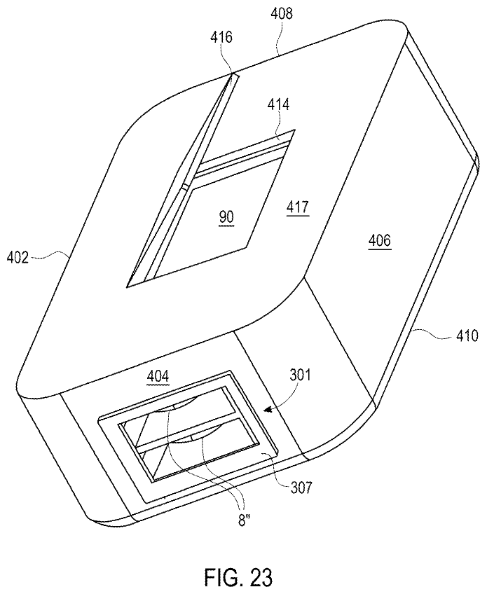

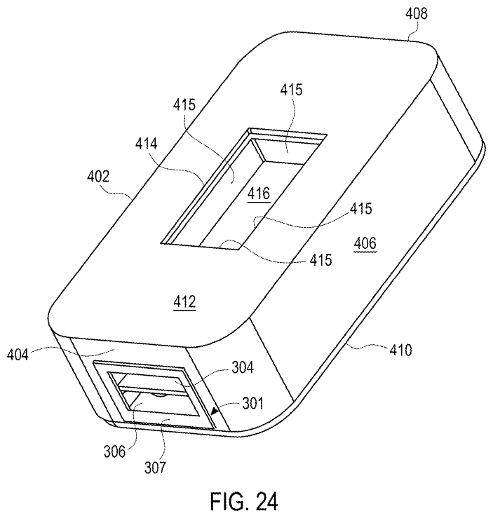

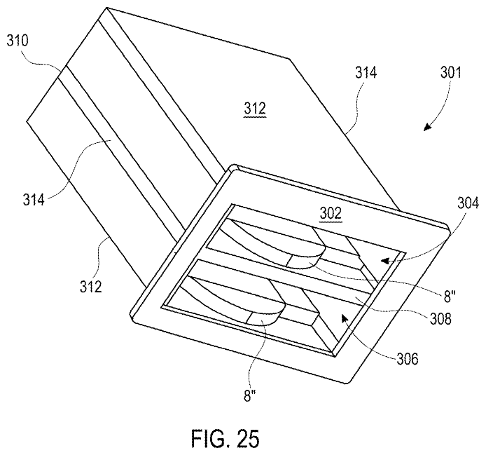

FIGS. 1-26 illustrate various embodiments of the wireless device holder of the present invention. While the one or more embodiments of the invention are illustrated with respect to certain features of the wireless device holder, it should be understood that any of the embodiments and/or features thereof illustrated with respect to one embodiment may be utilized with any of the other embodiments and/or features thereof.

FIGS. 1-3 depict various views of a device holder according to one embodiment of the present invention. The device holder 1 allows a user to charge a plurality of mobile devices simultaneously within a motorized vessel, such as marine craft, land recreational vehicles, and the like. A secured charging element 8 is disposed within the interior portion 14 of the device holder housing 2, and is capable of charging a plurality of mobile devices simultaneously. FIG. 1 depicts the device holder 1 having a secured charging plate or dual-surface charging element 8 for simultaneous charging of two separate mobile devices disposed within the interior portion 14 of the device holder housing 2. Charging element 8 is deemed a dual-surface charging element because it has charging surfaces on opposite sides 8a, 8b, including wireless charging circuitry adapted to wirelessly provide power transfer with the battery-charging surface of mobile devices simultaneously, and includes an electrical connector 24 which is encapsulated within the device holder 1 to prevent damage to the electrical components of both the charging element 8 and electrical connector 24.

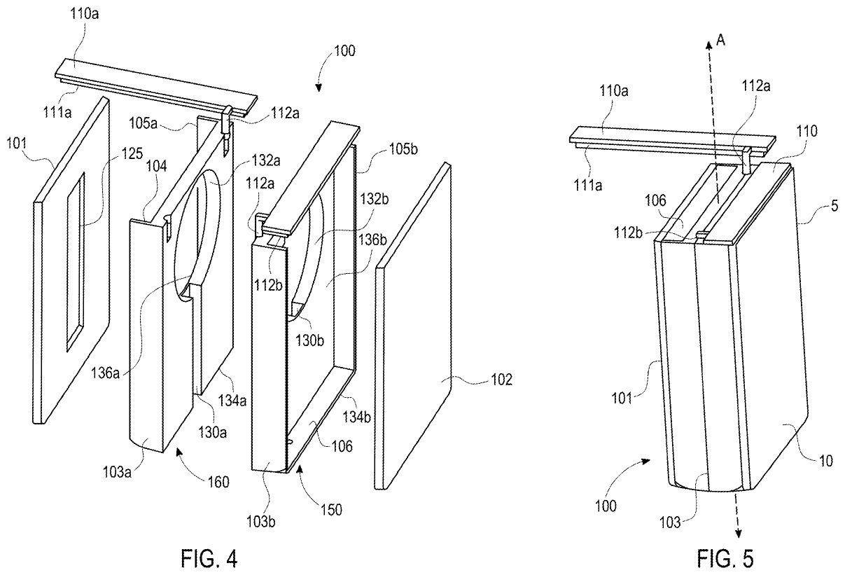

In some embodiments, the charging element 8 comprises a relatively thin, circular configuration similar to the cutout portions 132a, 132b depicted in FIG. 4, though other geometric configurations of the charging element 8 are not meant to be precluded. The size and shape of charging element 8 will depend on the specific application and desire of the manufacture but may be square, elliptical, rectangular, or any other configuration capable of performing battery charge/recharge operations of a mobile device.

The dual-surface charging element 8 may be secured centrally to the housing interior 14, although placements of the charging element 8 are not meant to be precluded. Device wells 4, 6 are formed on the device holder interior 14 and adjacent opposing surfaces of the charging element 8. Device wells 4, 6 are sized to receive mobile device(s) 20a, 20b in a clearance or transition fit engagement. Device wells 4, 6 may include a protective material, such as, for example, silicone or foam (not shown) to secure and/or engage the mobile device within wells 4, 6 and prevent damage to the mobile device(s).

Housing 2 may be constructed of a resilient, semi-flexible material to allowing flexing/deformation of device well(s) 4, 6 to accommodate a plurality of mobile device sizes and shapes within the device holder 1. Advantageously, elasticity of the semi-flexible material may produce a resilient force to bias the mobile device(s) 20a, 20b into a position proximate charging element 8, ensuring proper battery charge/recharge operations of the mobile device within the device holder 1.

The device holder can provide battery charge/recharge operations to 12V DC batteries such as nickel cadmium (NiCd) batteries, nickel metal hybrid (NiMH) batteries, lithium ion (Li-ion) batteries, lithium polymer (LiPo) batteries, and the like. Charging element 8 includes wireless charging circuitry adapted to wirelessly charge a mobile device. Upon direct or proximate contact of the mobile device(s) 20a, 20b with a charging face 8a, 8b of charging element 8, wireless charge/recharge operations of the mobile device(s) battery will ensue.

Device holder 1 may include a cover or shroud 10 (FIG. 1) sized to encapsulate interior portion 14 of the device holder housing 2, protecting sensitive electronics from weathering elements (e.g., temperature, moisture, ultraviolet (UV) radiation, and the like) when the device holder is subject to placement in an outdoor environment. Cover or shroud 10 may encapsulate interior portion 14, whether or not mobile devices have been engaged within wells 4, 6 (i.e., regardless of whether performing charge/recharge operations are occurring) to protect mobile device from weathering elements. Shroud 10 may be secured to the housing 2 via securing member 12 which may be a hinge, slide, or the like to move shroud 10 between an open/closed positions. Shroud 10 may include a latching mechanism 13 which may be a magnet, lock, or other latching mechanism. The device holder housing 2 and shroud 10 may be constructed of a material which is UV enhanced to protect sun-wear and/or premature failure of malfunction of the system.

Similarly, charging element 8 may be constructed of materials which are chemically and/or structurally resistant to weathering elements to reduce premature wearing or damage of charging element 8. In such cases, mobile device(s) 20a, 20b may thus be placed within device wells 4, 6 without encapsulating the interior 14 with cover or shroud 10. Advantageously, charge/recharge operations of mobile devices which are sized larger than device well(s) 4, 6 may be performed even in cases where any mobile device(s) extend beyond housing top rim 2a while within the device holder. One embodiment of the device holder comprises device wells 4, 6 sized to facilitate charging of a plurality of mobile devices within a single well 4, 6, allowing charge/recharge operations of one or more mobile devices via front surface 8a and/or rear surface 8b of charging element 8.

In some embodiments, the device holder 1 may incorporate a plurality of dual-surface charging elements 8 within the housing interior portion 14 to facilitate battery charge/recharge operations on 1, 2, 3, 4, or more mobile devices. Charging element 8 comprise wireless charging circuitry configured to provide wireless charge/recharge operations on a single charging surface of the charging element.

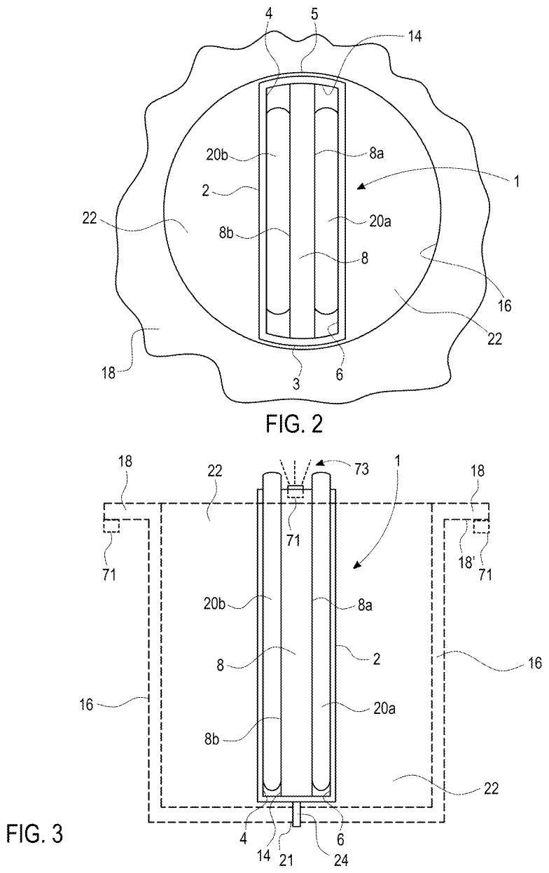

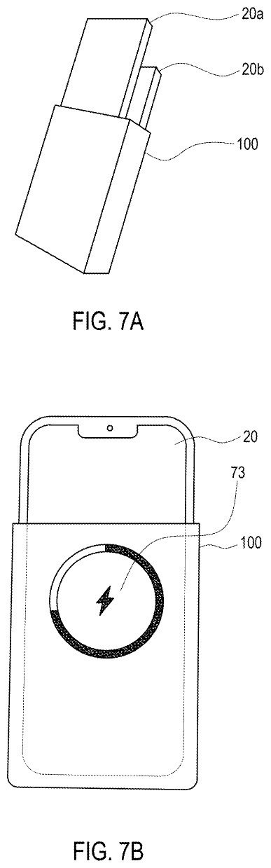

The device holder may be disposed in a receptacle cavity 22. The beverage receptacle 16 may be free-standing, or may be recessed below a horizontal surface 18 of a motorized vessel, as depicted in FIGS. 2 and 3. The beverage receptacle 16 may be constructed of a material comprising stainless steel, aluminum, aluminum alloys, plastic or plastic composites, or combinations thereof. The beverage receptacle and/or device holder 1 may incorporate optional lighted elements 71 to accent the products, facilitating further visibility of the beverage receptacle/device holder. These lighted elements 71 may be installed under the receptacle rim 18′ or anywhere within the receptacle cavity 22 or device holder 1. The lighted elements may further comprise individual lighted bulbs. The lighted elements may provide lighted indicia based on one or more parameters of the device holder (e.g., whether the mobile device is charging or fully charged, whether the mobile device has been proper/improper placement within the device well(s)). One embodiment utilizes light-coded error messages 73 to indicate when the device holder is damaged, malfunctioning, or otherwise in need of servicing (See also FIG. 7B).

The device holder 1 may be disposed anywhere within the receptacle cavity, and may be oriented within the receptacle cavity at an angle to the horizon, depending on the size and shape of the beverage receptacle. In some embodiments, the device holder 1 may be placed within the beverage receptacle 16 such that the receptacle cavity 22 may also house a beverage, wallet, or other object simultaneously with the device holder 1. In some embodiments, the housing 2 may include a curved side portion 3, 5 which may be contoured for complementary engagement with the size and shape of the open-ended beverage receptacle 16, further ensuring the device holder 1 is secured to the beverage receptacle cavity 22. In alternate embodiments of the invention, the device holder may be formed on and adjacent to the beverage receptacle to allow the place of objects within receptacle cavity 22 and separate from device holder 1.

Shroud 10 may be rotated about hinge 12 and secured to the outer housing 2 by means of a latch mechanism, locking mechanism, or other similar device, and may rotate or otherwise move along any plane respective to the receptacle cavity 22. The shroud 10 is shown coupled to hinge 12 for rotational movement, but may also be configured for translational movement in alternate embodiments of the invention.

The electrical connectors 24 may be secured to the device holder and exit through the receptacle cavity 22, which may be sealed using a waterproofing adhesive to prevent damage via weathering elements. These electrical connectors 24 may be connected by the original equipment manufacturer (OEM), original design manufacturer (ODM), or own brand manufacturer (OBM).

Electrical connector(s) 24 are sealed or “potted” at all interior/exterior connection points to prevent damage to electronics of the device holder. Electrical connector(s) 24 are run through the bottom of the device holder 1 to the exterior of the device holder during installation. Electrical connector(s) 24 are then run through a potted opening in the bottom portion of receptacle cavity 22 such that the electrical connector(s) 24 may be connected to a power source on the exterior of the installation surface. Electrical connector(s) 24 may comprise a fuse (not shown) installed on or within device holder 1, receptacle cavity 22, or the exterior power source.

Device holder 1 may be at least partially encapsulated by the sidewalls of the beverage receptacle 16 to prevent shifting of mobile device(s) 20a, 20b during operation of the motorized vessel or due to vibrations originating from the mobile device(s).

During installation of the device holder 1 within a beverage receptacle 16 received on a selected surface of a motorized vessel, electrical connectors 24 of the device holder are fed through the beverage receptacle bottom surface opening 21 to the interior of the motorized vessel which houses an external power source. Electrical connectors 24 are connected (hard-wired or otherwise) with the motorized vessel external power source, providing electrical power to the device housing and/or the beverage receptacle. To prevent moisture from damaging the electronics of the device holder, the opening 21 may be sealed using an epoxy, adhesive, and the like after connection of electrical connector with the motorized vessel external power source. The device holder 1 may subsequently be placed within the receptacle cavity 22, and may engage the cavity sidewalls in an interference fit, or be further sealed to the receptacle cavity 22 through adhesives, fasteners, and the like. The engagement of the device holder 1 with sidewalls of the beverage receptacle 16 prevents shifting of any mobile device(s) 20 placed within the device wells 4, 6 during operation of the motorized vessel.

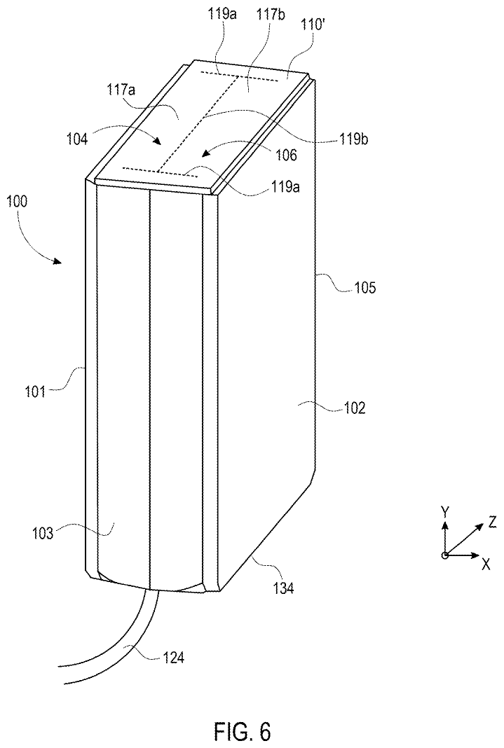

FIG. 4 depicts an exploded view of a device holder according to one embodiment of the present invention. Device holder 100 is formed from one or more case portions 150, 160. The case portions 150, 160 are sized to receive charging element 8 within opening 132a, 132b, and allows electrical connector 124 (See FIG. 6) to be installed to the exterior of the device holder 100 via channel 130a, 130b. Device holder 100 is sized to receive one or more mobile devices (not depicted) within device wells 104, 106 such that wireless charging may occur between the mobile device(s) and the charging element 8 in accordance to the embodiments described herein. Each case portion 150, 160 includes a side wall 136a, 136b opposite to a removable plate portion 101, 102 which is releasably coupled to the remainder of the case portion 150, 160, such as by fasteners or adhesives, and forms a closure preventing damage to the interior of the case portion 150, 160 by weathering elements. Connecting side wall(s) 136a, 136b is bottom wall(s) 134a, 134b, front wall(s) 103a, 103b, and rear wall(s) 106a, 106b. Plate portion(s) 101, 102 may include an opening 125 to allow for access to charging element 8 housed within the device holder 100 without need for removal.

With additional reference to FIG. 5, shroud portion(s) 110a, 110b may be sized to cover one or more of the device wells 104, 106 such that the shroud portion(s) 110a, 110b encapsulate device well(s) 104, 106, sealing the device interior from weathering elements which may damage device holder 100. In one embodiment, shroud portion(s) 110a, 110b is sized to cover a single device well 104, 106, and is secured to the case portion 150, 160 via stanchion member 112a, 112b. Stanchion member(s) 112a, 112b allow rotational movement of the shroud portion 110a, 110b to allow access to device well(s) 104, 106, and are designed for translational movement along longitudinal axis A. During closing operations, shroud portion(s) 110a, 110b may be moved laterally, rotationally, or a combination of the two along the longitudinal axis A and placed over the device well(s) 4, 6. The shroud portion(s) 110a, 110b may include connecting projection(s) 111a, 111b may be sized to fit within and engage the device well(s) 104, 106 in an interference fit.

FIG. 6 depicts a perspective views of a device holder according to one embodiment of the present invention. Device holder 100 may be suitable for placement outside of a beverage receptacle (not shown). The device holder 100 comprises electrical connector(s) 124 leading through bottom wall 134 and to the exterior of device holder 100. Device holder 100 is designed to provide access to mobile device(s) (not shown) having a plurality of dimensions, and includes insertion member 110′ which encloses device well(s) 104, 106, sealing the device interior from weathering elements which may damage device holder 100. Insertion member 110′ may comprise a thin, pliable membrane, which may be constructed of any resilient material, which is preferably non-abrasive and waterproof, such as silicone, rubber, and the like. Insertion member 110′ is shown having one or more cut or perforation portions 119a, 119b, 119c extending into insertion member 110′, creating slots for insertion of any mobile device(s) (not shown) within device wells 104, 106. Cut portions 119a, 119c extend along the horizontal (x-axis) of the insertion member 110′ substantially parallel to one another are intersected by cut portion 119b extending along the z-axis of insertion member 110′. Adjacent cut portion 119b tab portions 117a, 117b are formed and opposite one another with reference to cut portion 119b. Tab portions 117a, 117b are formed on insertion member 110′ such that each tab portions 117a, 117b are in communication with device wells 104, 106 respectively.

Upon placement of a mobile device within any device well(s) 104, 106, tab portions 117a, 117b are forced into the respective well(s) 104, 106 as a mobile device placed above tab portion 117a, 117b is urged downward onto the insertion member 110′. As the mobile device moves down the selected device well 104, 106, tab portion 117a, 117b will be forced into the corresponding device well 104, 106, opposite the device holder exterior wall 101, 102. Due to the resilient construction of the insertion member 110′, tab portion(s) 117a, 117b will urge a mobile device (not shown) placed within well(s) 104, 106 towards the charging element (not shown), facilitating proper contact between the mobile device and charging element to enable charge/recharge operations. While cut portion 119b is depicted at the approximate midpoint of cut portions 119a, 119c, but in alternate embodiments of the present invention intersecting cut portion 119b may be placed at any position on the insertion member 110′ to accommodate differently sized mobile devices. Insertion member 110′ including tab portions 117a, 117b secures the mobile device(s) within the device wells 104, 106, which are particularly advantageous for use in a motorized vessel or other location subject to shifting or other turbulence, as any mobile device(s) will be firmly secured within the device well, thereby eliminating the risk of loss or damage of the mobile device during operation of the motorized vessel.

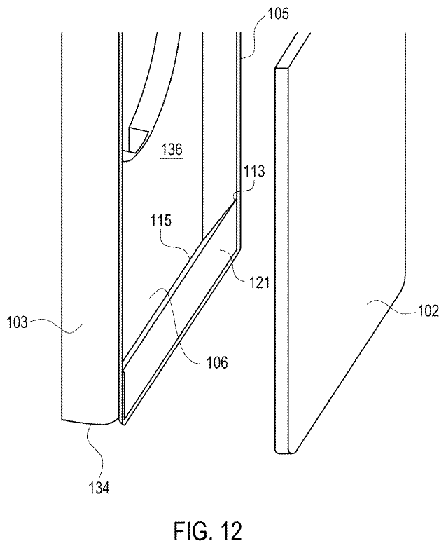

FIGS. 7A, 7B, 8 and 12 depicts perspective views of at least a portion of a device holder according to one embodiment of the present invention. To ensure proper placement of mobile device(s) 20 within device well(s) 104,106 proximate to the bottom end 134 of the device holder 100, the device well may comprise a ramped member 121, like those depicted in the exemplary view of FIG. 12. Ramped member 121 comprises an angled or ramped apex portion 113 and an opposing ramping portion 115. Ramped apex portion 113 and ramping portion 115 form an acute angle with respect to horizontal bottom end 134 (e.g., an angle in the range of 45 degrees to 55 degrees). Ramped apex portion 113 is secured within the interior of device well 104, 106 on the side proximate to exterior wall 101, 102, opposite dual-surface charging element 8. Opposing ramping portion 115 after placement within device well 104, 106 is proximate side wall 136a, 136b. Upon registration of the mobile device 20 with ramped member 121 disposed within device well 104, 106, the mobile device is biased towards side wall 136a, 136b due to the ramped structure of ramped member 121 between ramped apex portion 113 and ramping portion 115, which translates the vertical movement of mobile device(s) within the device well 104, 106 into horizontal movement towards side wall 136a, 136b, ensuring proper alignment and contact of mobile device(s) 20 with the charging element 8.

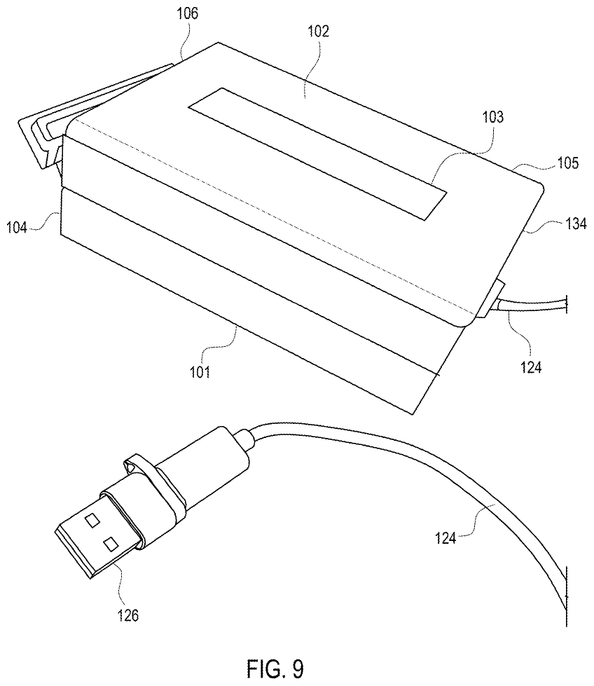

FIGS. 9-11 depict device holder 100 having electrical connector 124 leading through bottom wall(s) 134 to the exterior of the device holder. The electrical connector 124 may comprise a connecting element 126 which may comprise a USB, a two-prong plug, a three-prong plug, an auxiliary power plug (such as those which are acceptable for use with 6V and 12V auxiliary plug receptacles), or the like. Charging element 8 may provide charge/recharge operations of one or more mobile devices 20 simultaneously within device wells 106, 104. Connecting element 126 is capable of supplying a power source to the device holder 100 via an external power source, and may comprise an auxiliary connecting element 125 connected to main connector 126 in alternate embodiments of the present invention. Device holder 100 may therefore be placed in locations other than a beverage receptacle (not shown), and does not require a “potted” direct connection from the device holder, through the beverage receptacle, to an external power source. The device holder is sized for placement within any suitable location, including the interior storage compartment of a motorized vessel. Similarly, the device holder 100 may be removably secured to a clamping system of a motorized vessel or console, and provides for storage of mobile devices in different locations when not in use. In one embodiment, the connecting element 126 may be placed on the bottom walls 134a, 134b of the device holder 100, thereby limiting the need for excess wires. In alternate embodiments of the present invention, a receptacle may be placed on the bottom walls 134a, 134b to receive a separate and removable electrical connector/connecting element therein. To supply power to the device holder, a user may insert the connecting element 126 or auxiliary connecting element 125 within the receptacle 128, which is wired at end 130 to the primary power source of the motorized vessel.

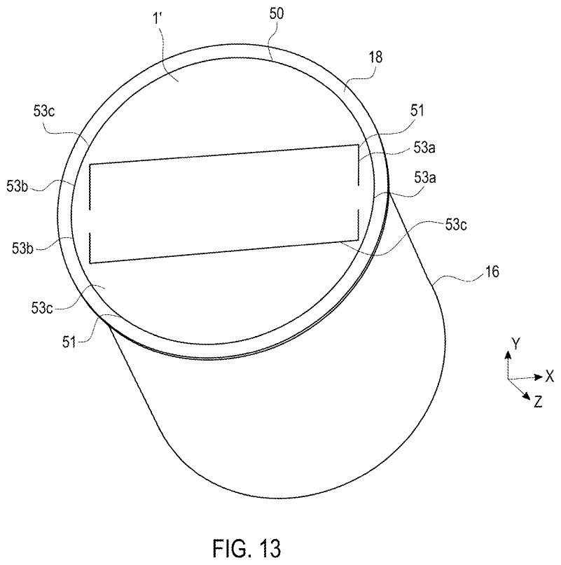

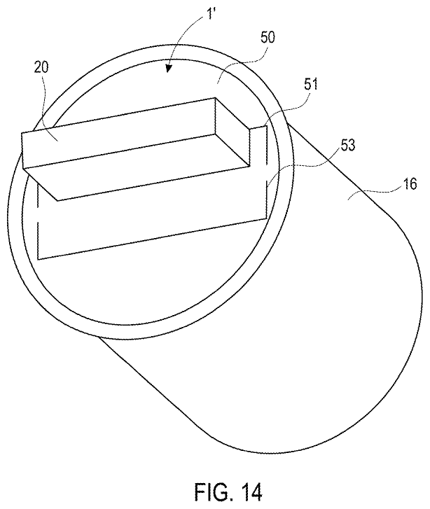

Turning now to FIGS. 13-19, an embodiment of the present invention is depicted which incorporates a plurality of charging elements for charge/recharge operations within a beverage receptacle. The device holder 1′ may be disposed within a beverage receptacle 16, and may be diagonally or at an angle depending on the size and shape of the beverage receptacle. The device holder 1′ comprises a resilient cover portion 50, which includes one or more cut or perforation portions 53a, 53b, 53c extending into cover portion 50, creating slots that allow for the placement of a mobile device 20 within device wells 64, 66. Cover portion 50 comprises a resilient and sufficiently nonabrasive material, including silicone, rubber, and the like. As depicted in the illustrative view of FIG. 13, cut portions 53a, 53b extend along the horizontal (y-axis) of the cover portion 50 substantially parallel to one another. Connecting cut portions 53a and 53b, cut portion 53c extends along the x-axis of cover portion 50, connecting the cut portions at a top end closest to the rim 18′ of beverage receptacle 16. Adjacent cut portion 53c, tab portions 51 are formed and are in communication with device wells 64, 66 within the interior of the beverage receptacle 16. Upon insertion of any mobile device(s) within the device well(s) 64, 66, tab portions 51 are forced within the device well(s) 64, 66 opposite the charging element 8′. As the mobile device moves downward within the selected device well 64, 66, tab portion 51 will are forced between the mobile device 20 and the inner divider portion 68. With the mobile device(s) in the inserted positions, tab portion(s) 51 will urge the mobile device(s) towards sidewalls 67 of the inner housing 60, and into a position proximate charging element 8′ such that charge/recharge operations of the mobile device battery is initiated. In addition to securing mobile device(s) within device well(s) 64, 66, tab portions 51 will ensure proper contact between the mobile device(s) 20 and the charging element(s) 8′. Cut portions 53a, 53b, 53c may be located at approximate midpoint of the beverage receptacle 16, or any location on the cover portion 50 to accommodate mobile devices of any size. Cover portion 50 secures the mobile device(s) within the device wells 64, 66, which is particularly advantageous for use in a motorized vessel or other location subject to sudden shifting or other turbulence, as any mobile device(s) will be firmly secured within the device well, thereby eliminating the risk of loss or damage of the mobile device during operation of the motorized vessel.

Cover portion 50 provides both tactile and visual identification to an end user that the beverage receptacle 16 contains the device holder 1′, thereby eliminating the risk that a user would attempt to place a beverage within the device holder, which could damage any electronics therein. Similar to other embodiments described herein, the device holder 1′ may be constructed of a material which is UV enhanced to protect sun-wear and/or premature failure of malfunction of the system. Cover portion 50 and device holder 1′ can then be welded or bonded together using solvent, adhesive, spin-welding, vibration-welding, ultrasonic-welding, or laser-welding techniques.

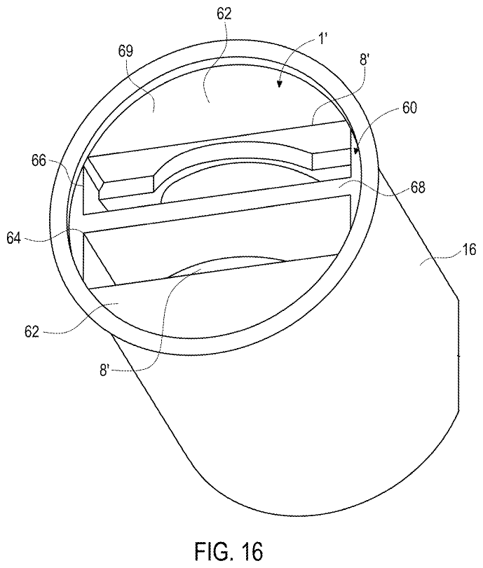

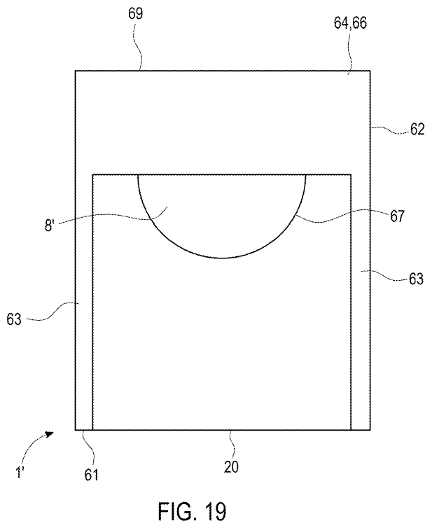

FIG. 16-19 depict perspective views of a device holder according to one embodiment of the present invention, displaying the inner housing with removed cover portion. Inner housing 60 generally comprises includes a base portion 61 connected by extending sidewalls 67, and contoured edges 63. Device wells 64, 66 are formed within the inner housing top end 69 and extending towards the base portion 61, separated by divider portion 68. A semi-hemispherical flange extension(s) 62 extends from the housing adjacent device wells 64, 66. Proximate the top end 69 of the inner housing, opening 67a extends into the housing such that a charging element 8′ may be placed therein. The device holder of the embodiment depicted may facilitate charge/recharge operations on a single surface of the device holder, and the electrical connector (not shown) of each charging element 8′ may be potted within the beverage receptacle interior in a manner similar to those of the previously described embodiments. As depicted in the cross-sectional view of FIG. 19, the mobile device 20 is placed within a device well 64, 66 such that that the bottom surface 61 of the housing may be proximate the bottom surface of the beverage receptacle 16, similar to the embodiments which are depicted in FIGS. 2-3.

The inner housing 60 provides a sealed housing, and electrical connector(s) of the charging element(s) 8′ may be exited via openings within the bottom of the housing and beverage receptacle for attachment to an external power source. The openings may then be potted and sealed to withstand exposure to weathering elements.

The inner housing 60 may similarly include a shelf portion 70, which is proximate the housing top surface 69 to provide additional clearance to a mobile device within device well(s) 64, 66, such as in situations in which the mobile device comprises a projecting feature such as a camera lens and the like, to damage to the projecting feature upon placement of the mobile device within the device well. The bottom portion of the device wells 64, 66 which are adjacent the bottom surface 61 of the housing may additionally comprise a ramped member similar to those depicted in FIG. 12 to bias the mobile device into a position which ensures proper charge/recharge operations of mobile devices of varying sizes. The inner divider portion 68 or anywhere within the device well(s) 64, 66 may include one or more ribs 80 on the surface. The number of ribs 80 will depend on the specific application and desire of the manufacture but may include 1, 2, 3, 4, 5, or more ribs. Ribs 80 may be constructed of a resilient material which do not scratch the mobile device but will further bias the mobile device towards the respective well charging element(s).

The device holder 1′ may include LED lighting, ambient lighting or other visual indicia. The lighting may provide different colored light which would indicate to the end user that the wireless device has been properly inserted within the device holder, improperly inserted, that a charging operation has begun, or is finished. Further, the lighting effects may also provide a visual aid to the end user to locate the device wells of the device, and may be particularly advantageous during nighttime operations of the vessel utilizing the device holder. Other programmable LED lighting operations are not meant to be precluded. While the device holder described above may be placed in a single beverage receptacle, other beverage receptacle designs are not meant to be precluded, including two or three beverage receptacle designs.

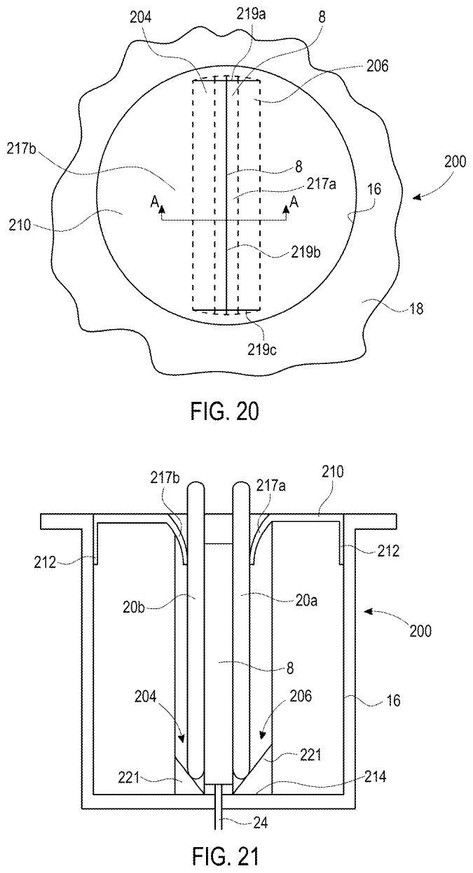

FIGS. 20 and 21 depict top plan and cross sectional views of a device holder according to one embodiment of the present invention. The device holder 200 comprises a single dual-surface charging element 8 which is approximately central the beverage receptacle 16 with which the device is contained. Device wells 204, 206 are located on opposing sides of the charging element 8 for placement of a mobile device 20a, 20b therein. The charging element 8 comprises an electrical connector 24, which is potted in the lower portion 14 of the device holder 200. A ramped member 221 is disposed in each device well 204, 206 proximate lower portion 14 to ensure proper registration of a mobile device 20a, 20b with the charging element 8. Encapsulating the beverage receptacle at the top surface 18 is a cover portion 210 comprising a resilient and nonabrasive material, such as silicone, rubber, or the like. An annular flange 212 is sized to fit within and engage the interior portion of the beverage receptacle 16 in an interference engagement. In alternate embodiments of the present invention, flange 212 may be secured to the beverage receptacle 16 by way of an adhesive, or detent mechanism including tabs and slots or a threaded portion.

Cover portion includes cut portions 219a, 219b, 219c aligned with device well(s) 204, 206 and charging element 8 such that tabbed portions 217a, 217b will be deflected into the corresponding device well(s) 204, 206 after placement of the mobile device(s) 20a, 20b therein (See FIG. 21). The tabbed portions 217a, 217b will deflect the mobile device(s) 20a, 20b towards the charging element 8, ensuring proper registration of the mobile device with the charging element 8 to provide charge/recharge operations.

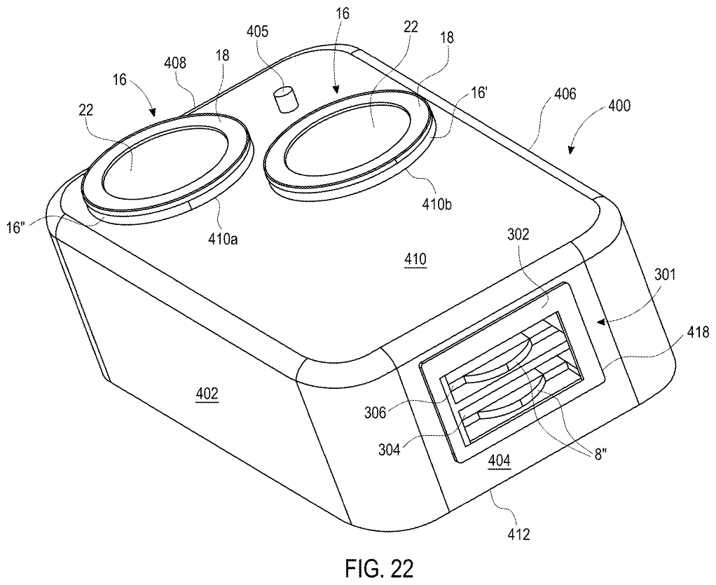

FIGS. 22-25 depict perspective views of a device holder according to one embodiment of the present invention, which may be installed on a portable, resilient housing. Device holder 301 is received within an interior chamber 418 on a resilient housing 400. Resilient housing 400 comprises a rectangular construction having a top surface 410, a bottom surface 412, enclosed by sidewalls 402, 404, 406, 408. The resilient housing 400 may be constructed of any durable and resilient material, such as polymers, wood, or the like, and may further comprise an external upholstered covering to provide a soft, comfortable surface to an end user. While resilient housing 400 is shown having a rectangular construction, other shapes and sizes for the housing are not meant to be precluded. To provide a durable and comfortable surface, the housing may include tapered or contoured surfaces to prevent damaging the external upholstered covering. Top surface 410 may include one or more openings 410a, 410b to receiving a beverage receptacle 16 comprising a beverage cavity 22, and beverage rim 18. Beverage receptacle 16 is placed within the resilient housing 400 such that the beverage rim will be received flush or slightly above top surface 410. Beverage receptacle 16 may further comprise lighted elements 16′ which may include LED lighting (programmable or otherwise), ambient lighting or other visual indicia. The lighted elements may provide a light source as a single color, RGB, RGBW, or any combination thereof. Beverage receptacle 16 may be constructed of a material comprising metals and metallic alloys, organic polymers, inorganic polymers, thermoplastic polymers, or any combination thereof. A switch 405 may be included on the top surface 410 to provide a power source to the electrical components of the resilient housing 400, such as device holder 301, lighted elements 16′ and combinations thereof.

The bottom surface 412 of the resilient housing 400 may include a cavity 414 for placement of a power cell 90 therein. Power cell 90 may comprise a rechargeable battery power supply, such as a 12V DC NiCd battery, NiMH battery, Li-ion battery, LiPo battery, and the like. Power cell 90 supplies electrical energy to the electrical components within the resilient housing 400, and is insertable within into cavity 414 via a connection element 416 on the bottom surface of cavity 414 surrounded by sidewalls 415. Connection element 416 provides an interface to receive power cell 90 to provide an end user with a quick insertion and removal of the power cell. A lid 411 may be included to provide access to cavity 414, and a closure element (not shown) may be provided to form a detent mechanism with cavity 414 to retain and secure power cell 90 within the cavity. When closed, lid 416 prevents damaging to the connection element 416 and power cell 90 which may result from exposure to weathering elements.

One or more housing sidewalls 402, 404, 406, 408 may include a cutout or opening to create an interior chamber 418 for housing device holder 301. Device holder 301 comprises a housing having base 310 with upstanding lateral sidewalls 314 and longitudinal sidewalls 312. The device holder interior comprises two device wells 304, 306 separated by partition element 308. Each device well 304, 306 includes a wireless charging element 8″ for placement of a mobile device (not shown) within the device holder 301. Mobile devices are placed within the device holder 301 in accordance with the previous embodiments described herein for wireless charging of the devices. A flanged plate cover 302 is provided on the sidewalls 314, 312 to secure the wireless device holder 301 to the resilient housing 400 via mechanical fasteners, adhesives and the like. Due to the configuration of the device holder 301, mobile devices may remain in communication with the charging element 8″ via gravitational forces, though any of the aforementioned methods may be incorporated on the device holder 301 to maintain electrical charging of the wireless device within the device wells. Device holder 301 may further include LED lighting (programmable or otherwise), ambient lighting or other visual indicia to indicate if the wireless device has been properly inserted within a device well, is in the process of charging, or is fully charged. In addition, visual indicia may additionally indicate if the power cell is fully charged, or if it is in need of a charge.

Advantageously, the wireless device incorporated within the resilient housing 400 may be used in connection with motorized vessels, as well as in household applications and the like. Due to the removable and rechargeable power cell 90, a user may open the housing lid, remove the power cell for recharging purposes on a separate power cell device holder. Once recharged, the user may simply place the power cell back within the charging cavity to electrically power the electronic components of the resilient housing 400.

In some embodiments, the power cell 90 may also be recharged by way of an electrical outlet, electrical connector, or the like (not shown) in the resilient housing 400 or power cell 90 for electrical communication between the power cell 90 and an external electrical power source for recharging operations of the power cell. Thus, the resilient housing can accommodate recharging operations in situations which utilize auxiliary power receptacles, such as auxiliary power outlets of motorized vessels. The power cell 90 may be of a standard size for easy, cost effective replacement, if needed. The power cell 90 may provide DC electrical power to the electrical elements of the housing 400, such as the device holder 301, beverage receptacle(s) 16, or any combination thereof. In some embodiments, the housing 400 may include additional electrical outlets (not shown) for other devices, such as USB ports, and the like.

As electrical power is supplied to device holder 301, beverage receptacle(s) 16, and the other electrical elements therein, resilient housing 400 makes for a portable mobile device and beverage holder ideal for use in motorized vessels, as well household applications.

The resilient housing 400 may be rectangular, square, or may have rounded corners. In some embodiments, the resilient housing may comprise a rear locking flap (not shown), such as a hook and loop connecting flap, or the like that when placed adjacent a seat back or seat cushion within a motorized vessel will secure resilient housing 400, preventing sliding or shifting during moving operations.

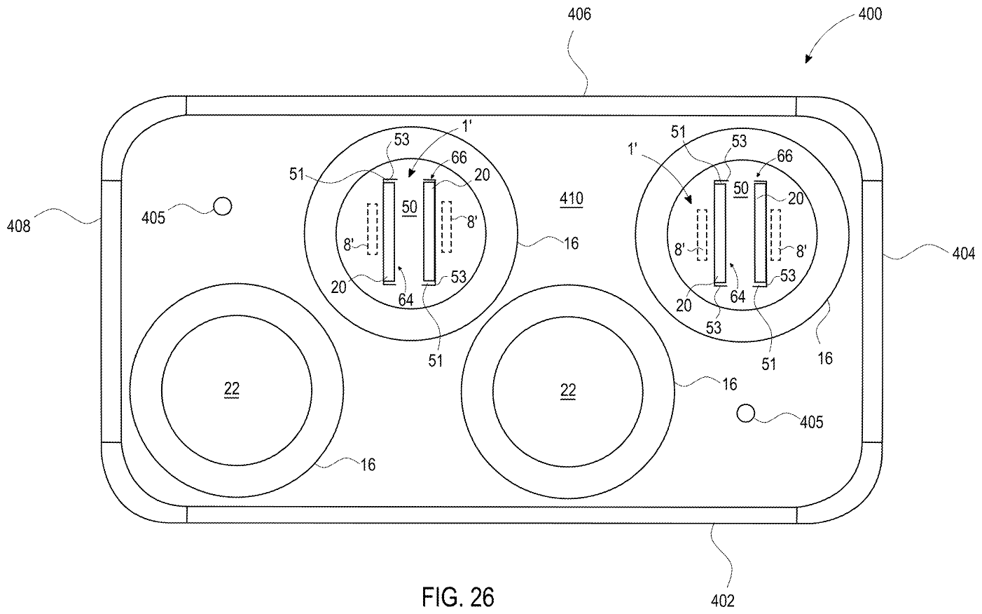

FIG. 26 depicts a top plan view of a device holder according to an alternate embodiment of the present invention. Resilient housing 400 comprises a rectangular construction having a top surface 410, a bottom surface (not shown), enclosed by sidewalls 402, 404, 406, 408. The resilient housing 400 may be constructed of any durable and resilient material, such as polymers, wood, or the like, and may further comprise an external upholstered covering to provide a soft, comfortable surface to an end user. While resilient housing 400 is shown having a rectangular construction, other shapes and sizes for the housing are not meant to be precluded. To provide a durable and comfortable surface, the housing may include tapered or contoured surfaces to prevent damaging the external upholstered covering. Top surface 410 may include one or more beverage receptacle(s) 16 having a beverage cavity 22. Beverage receptacle 16 is placed within the resilient housing 400 such that the beverage rim will be received flush or slightly above top surface 410. Beverage receptacle 16 may further comprise lighted elements (not shown) which may include LED lighting (programmable or otherwise), ambient lighting or other visual indicia. The lighted elements may provide a light source as a single color, RGB, RGBW, or any combination thereof. Beverage receptacle 16 may be constructed of a material comprising metals and metallic alloys, organic polymers, inorganic polymers, thermoplastic polymers, or any combination thereof. One or more switches 405 may be included on the top surface 410 or any other surface of the resilient housing 400 to provide a power source to the electrical components of the resilient housing 400, such as device holder 1′, lighted elements and combinations thereof. Switch(es) may comprise a toggle switch, rotational switch, and the like to provide a power source to one or more electrical components of the resilient housing 400.

The bottom surface (not shown) or any other surface of the resilient housing 400 may include a removable power cell (not shown) for supplying electrical energy to the electrical components of the resilient housing. Power cell (not shown) may comprise a rechargeable battery power supply, such as a 12V DC NiCd battery, NiMH battery, Li-ion battery, LiPo battery, and the like. Power cell (not shown) may be received within the resilient housing 400 via a connection element (not shown). Connection element provides an interface to receive power cell (not shown) to provide an end user with a quick insertion and removal of the power cell.

A device holder 1′ may be disposed within one or more beverage receptacle 16 on the housing top surface 410. The device holder 1′ comprises a resilient cover portion 50, which includes one or more cut or perforation portions 53 extending into cover portion 50, creating slots that allow for the placement of a mobile device 20 within device wells 64, 66. Cover portion 50 comprises a resilient and sufficiently nonabrasive material, including silicone, rubber, and the like. Tab portions 51 are formed and are in communication with device wells 64, 66 within the interior of the beverage receptacle 16. Upon insertion of any mobile device(s) 20 within the device well(s) 64, 66, tab portions 51 are forced within the device well(s) 64, 66 opposite the charging element 8′. As the mobile device moves downward within the selected device well 64, 66, tab portion(s) 51 will urge the mobile device(s) 20 towards charging element 8′ such that charge/recharge operations of the mobile device battery is initiated. In addition to ensure proper contact between the mobile device(s) 20 and the charging element(s) 8′, tab portions will secure mobile device(s) within device well(s) 64, 66 to prevent sudden shifting or dislodging of mobile device(s) from the device well(s), thereby eliminating the risk of loss or damage of any mobile device(s), particularly during operation of a motorized vessel utilizing the resilient housing 400.

Cover portion 50 provides both tactile and visual identification to an end user that the beverage receptacle 16 contains the device holder 1′, thereby eliminating the risk that a user would attempt to place a beverage within the device holder, which could damage any electronics therein. Similar to other embodiments described herein, the device holder 1′ may be constructed of a material which is UV enhanced to protect sun-wear and/or premature failure of malfunction of the system. Cover portion 50 and device holder 1′ can then be welded or bonded together using solvent, adhesive, spin-welding, vibration-welding, ultrasonic-welding, or laser-welding. Device holder 1′ may further include LED lighting (programmable or otherwise), ambient lighting or other visual indicia to indicate if the wireless device has been properly inserted within a device well, is in the process of charging, or is fully charged. In addition, visual indicia may additionally indicate if the power cell is fully charged, or if it is in need of a charge.

The present invention advantageously allows an individual to charge a plurality of wireless devices simultaneously in a single device holder. In addition, preexisting beverage receptacles may be utilized to house the device holder. The present invention also provides an auxiliary charging device which may utilized in locations other than a beverage receptacle, and utilize a plurality of charging operations. Thus, the present invention allows for the safe and secure placement of a wireless device within a vessel or other form of recreational vehicle that additionally allows for charging operations. These charging operations may be made through resilient forces, without reliance on gravitational and/or magnetic forces to achieve.

Thus, the present invention provides one or more of the following advantages: a safe and secure storage solution to a mobile device within motorized vessel(s); storage of any mobile device(s) which may performing wireless charging/recharging operations of the device battery when not in use; storage and/or wireless charge/recharge options to a plurality of mobile devices simultaneously in a single storage housing; storage and/or wireless charge/recharge options for mobile device(s) utilizing any pre-existing beverage receptacle(s) of a motorized vessel; and portable storage for mobile device(s) in a motorized vessel capable of performing wireless charge/recharge operations.

Although specific embodiments have been illustrated and described herein, those of ordinary skill in the art appreciate that any arrangement which are calculated to achieve the same purpose may be substituted for the specific embodiments shown and that the present disclosure has other applications in other environments. This application is intended to cover any adaptations or variations of the present disclosure. The descriptions provided herein are in no way intended to limit the scope of the present disclosure to the specific embodiments described herein.

Thus, having described the invention, what is claimed is:

1. A device holder for wirelessly providing power to at least one mobile device, comprising:
a housing having a vertically extending first device well and a vertically extending second device well, the device wells configured for receiving at least one mobile device;
a charging element disposed central to the housing and between the first and second device well, the charging element including a front surface in communication with the first or second device well, a rear surface in communication with the second or first device well, and wireless charging circuitry adapted to wirelessly charge at least one mobile device inserted into the first and/or second device wells; and
wherein upon placement of at least one mobile device within the first and/or second device well, the charging element front surface and/or rear surface perform wireless charging of the at least one mobile device.

2. The device holder of claim 1, further comprising a shroud or cover coupled to an end of the housing, the shroud or cover capable of encapsulating the device wells.

3. The device holder of claim 1, wherein the device holder is secured within a beverage receptacle of a motorized vessel.

4. The device holder of claim 3, wherein the beverage receptacle includes lighted elements to indicate one or more parameters of the device holder.

5. The device holder of claim 4, wherein the one or more parameters comprise when at least one mobile device is charging or fully charged, when at least one mobile device has been properly and/or improper placement within the first and/or second device well, when the device holder is damaged, malfunction or in need of service, and combinations thereof.

6. The device holder of claim 1, wherein the charging element wireless charging circuitry is adapted to wirelessly charge a plurality of mobile devices inserted into the first and/or second device well.

7. The device holder of claim 6, wherein the charging element front surface performs wireless charging of one of the plurality of mobile devices inserted into the first device well and/or the second device well and the rear surface perform wireless charging of the other of the plurality of mobile devices inserted into the second device well and/or the first device well.

8. The device holder of claim 1, wherein the housing is constructed of a UV enhanced material.

9. The device holder of claim 1, further comprising a plurality of shroud portions coupled to an end of the housing, each of the plurality of shroud portions adapted to be received within one of the device wells, each of the plurality of shroud portions comprising stanchion members and connecting projections.

10. The device holder of claim 1, wherein an end of the housing includes an insertion member to enclose the device wells, the insertion member including tab portions in communication with the device wells.

11. The device holder of claim 1, wherein each of the device wells include a ramped member configured to bias at least one mobile device inserted into the first and/or second device well toward the charging element.

12. The device holder of claim 1, further comprising a connecting element capable of supplying electrical power to the device holder via an external power source.

13. A device holder for wirelessly providing power to at least one mobile device, the device holder disposed within a beverage receptacle of a motorized vessel, the device holder comprising:
an inner housing having a vertically extending first device well and a vertically extending second device well, the device wells configured for receiving at least one mobile device;
a first charging element within the inner housing, the first charging element in communication with one of the device wells and including wireless charging circuitry adapted to wirelessly charge at least one mobile device inserted into the one of the device wells;
a second charging element within the inner housing, the second charging element in communication with the other of the device wells and including wireless charging circuitry adapted to wirelessly charge at least one mobile device inserted into the other of the device wells; and
a cover portion enclosing the device wells, the cover portion including tab portions in communication with the device wells to bias at least one mobile device inserted within the first and/or second device well towards the first and/or second charging element;
wherein upon placement of at least one mobile device within the first and/or second device well, wireless charging of the at least one mobile device occurs via the first and/or second charging element.

14. The device holder of claim 13, wherein the beverage receptacle includes lighted elements to indicate one or more parameters of the device holder.

15. The device holder of claim 14, wherein the one or more parameters comprise when at least one mobile device is charging or fully charged, when at least one mobile device has been properly and/or improper placement within the first and/or second device well, when the device holder is damaged, malfunction or in need of service, and combinations thereof.

16. The device holder of claim 13, wherein the device holder is constructed of a UV enhanced material.

17. The device holder of claim 13, wherein the device wells include a ramped member configured to bias at least one mobile device inserted into the first and/or second device well toward the first and/or second charging element.

18. The device holder of claim 13, further comprising a connecting element capable of supplying electrical power to the device holder via an external power source.

19. A device holder for wirelessly providing power to at least one mobile device, the device holder comprising:
a resilient housing comprising a top surface, a bottom surface, and enclosed by sidewall s;
a device holder housing disposed within the resilient housing, the device holder having a plurality of device wells, each of the plurality of device wells configured for receiving at least one mobile device;
a beverage receptacle disposed on the resilient housing top surface;
the resilient housing including a connection element for receiving a removable power cell for supplying electrical energy to the resilient housing; and
each of the plurality of device wells including a charging element including wireless charging circuitry adapted to wirelessly charge at least one mobile device inserted into at least one of the plurality of device wells;
wherein upon placement of at least one mobile device within at least one of the plurality of device wells, the charging element perform wireless charging of the at least one mobile device.

20. The device holder of claim 19, wherein the beverage receptacle comprises a plurality of beverage receptacles disposed on the resilient housing top surface.

21. The device holder of claim 19, wherein the device holder includes lighted elements to indicate one or more parameters of the device holder.

22. The device holder of claim 21, wherein the one or more parameters comprise when at least one mobile device is charging or fully charged, when at least one mobile device has been properly and/or improper placement within at least one of the plurality of device wells, when the device holder is damaged, malfunction or in need of service, and combinations thereof.

23. The device holder of claim 19, wherein the device holder is disposed within an interior chamber on one of the sidewalls of the resilient housing.

24. The device holder of claim 20, wherein the device holder is disposed within one of the plurality of beverage receptacle, the device holder including a cover portion enclosing the device wells, the cover portion including tab portions in communication with the device wells to bias at least one mobile device inserted into at least one of the plurality of device wells towards the charging element.

25. The device holder of claim 24, wherein each of the plurality of device wells include a ramped member configured to bias at least one mobile device inserted into at least one of the plurality of device wells toward the charging element.

26. The device holder of claim 19, further comprising an electrical connector in the resilient housing capable of supplying electrical power to the device holder via an external power source.

27. A method of installing a device holder for wirelessly providing power to at least one mobile device within a beverage receptacle of a motorized vessel, the method comprising the steps of:
feeding an electrical connector of a device holder through a bottom surface opening of a beverage receptacle, the beverage receptacle received within a selected surface of a motorized vessel;
placing the electrical connector of the device holder into an interior of the motorized vessel;
connecting the electrical connector of the device holder with an external power source of the motorized vessel;
sealing the bottom surface opening of the beverage receptacle;
placing the device holder within a cavity of the beverage receptacle; and
engaging the device holder with sidewalls of the beverage receptacle to prevent shifting of at least one mobile device placed within the device holder during operation of the motorized vessel.

28. A device holder for wirelessly providing power to at least one mobile device, comprising:
a housing secured within a beverage receptacle of a motorized vessel, the housing having a vertically extending first device well and a vertically extending second device well, the device wells configured for receiving at least one mobile device;
a charging element disposed central to the housing and between the first and second device well, the charging element including a front surface in communication with the first or second device well, a rear surface in communication with the second or first device well, and wireless charging circuitry adapted to wirelessly charge at least one mobile device inserted into the first and/or second device wells; and
wherein upon placement of at least one mobile device within the first and/or second device well, the charging element front surface and/or rear surface perform wireless charging of the at least one mobile device.
